(19) United States
(12) Patent Application Publication
(10) Pub. No.: US 2013/0332202 A1
(43) Pub. Date: Dec. 12, 2013

(54) Systems and Methods for Advancing Construction Project Performance and Completion

(71) Applicant: Adam W. Downs, Greenwich, CT (US)

(72) Inventor: Adam W. Downs, Greenwich, CT (US)

(21) Appl. No.: 13/494,541

(22) Filed: Jun. 12, 2012

(51) Int. Cl. G06Q 40/08

(52) U.S. Cl. 705/4

(57) ABSTRACT

Exemplary methods and systems for advancing construction project performance and completion are provided, including creating a contract between a first party and a second party, determining a need for at least one performance guarantee, and determining an amount of at least one letter of credit. The exemplary methods further include incorporating the at least one letter of credit into the at least one performance guarantee and incorporating the at least one performance guarantee into at least one of the contract and a surety bond. Upon a default by at least one of the first party and the second party, the exemplary method includes implementing at least one of the at least one performance guarantee and the at least one letter of credit to cure the default. The exemplary system includes a computer storage device and a processing device.

### TECHNICAL FIELD

The present disclosure relates to systems and methods for construction project performance and completion. In particular, the present disclosure is directed to systems and methods for advancing construction and/or development of improvement projects such that they are completed as designed, on time and on budget, and/or to provide an efficient and immediate remedy for curing a default in connection with a construction and/or development project.

### BACKGROUND

Conventionally, in the construction of public and private improvements, owners attempt to ensure that their projects are completed as designed, on time and on budget, by requiring the project's contractor, e.g., a general contractor, subcontractor, construction manager, supplier, energy exploration or extraction company, and the like (hereinafter generally referred to as “contractor”), to supply bid, performance, and payment bonds issued by a construction surety. These bonds are marketed as a means of providing funds to assure that projects are built as designed, on time, and on budget, as set forth in the contract documents in the event of contractor default. In practice, currently existing surety bonds routinely fail to deliver their marketed benefits, in whole or in part, thereby resulting in an unnecessary overabundance of delayed projects, cost overruns, and, on public projects, unnecessary expense borne by the taxpayer.

A number of factors generally contribute to a surety's failure to fully deliver their marketed benefits. Though an owner is generally designated the “beneficiary” on a construction surety bond, the surety's fee, while passed on to the owner, is generally paid to the surety by the contractor. Accordingly, a surety's client is generally the contractor, not the owner. In particular, a surety stands to obtain repeat business from a contractor, not the owner. Indeed, other than remaining authorized to issue surety bonds, sureties generally have no economic incentive to comply with their obligations under the surety bonds that they issue in the event of a claim against the bond. Accordingly, under the current model, when a dispute arises and a surety bond claim is made by the owner, a surety seeking repeat business generally has an incentive to side with the contractor, not the owner. Further, since sureties generally require approximately 100% reimbursement from the contractor for any monies paid in connection with a claim, contractors, and therefore sureties, are generally motivated to deny bond claims, delay payment and/or avoid payment. In general, all that a surety requires to deny a surety bond claim is a statement from the contractor that it is in conflict with the owner's claim of contractor default. Since a contractor has provided the surety with a payment reimbursement guarantee, and likely a personal guarantee from the contractor's principals and/or members, the contractor has every incentive to deny the facts supporting an owner's surety bond claim. Once the contractor takes a position contrary to that of the owner's, the surety generally denies the surety bond claim pending judicial resolution or settlement between the parties. Sureties can take months, if not years, to investigate a claim against a surety bond. After a surety bond claim has been denied, the owner generally only has two options, accept the determination or sue the surety.

Given the complexity of the construction industry and a surety's experience with litigating and prolonging surety bond claims, lawsuits against construction sureties may last years. This type of delay can force an owner seeking to move its project forward to either finance the increased costs of project completion itself or accept a settlement offer from the surety that is significantly less than the amount properly due. In either situation, the owner loses and is not provided the benefit of its bargain, as promised, under the terms of the surety bond.

In addition, since contractors are constantly seeking a larger “bonding capacity”, which enables them to take on more work, sureties seeking business are compelled to issue bonds in amounts greater than their competitors. The practice generally leads to contractors obtaining bonds in amounts greater than they should and contractors bidding on work that they are not properly qualified to perform. When contractors obtain bonds in amounts greater than they should and perform work that they are not properly qualified to perform, they increasingly default. The default, in and of itself, is not a problem for the surety. However, since the contractor who obtained bonds in excessive amounts cannot repay the surety if the surety were to pay the surety bond claim, the currently existing model motivates sureties to seek to delay and avoid their payment obligations rather than incur the loss. Moreover, under the currently existing model, surety bonds generally provide no protection to the contractor in the event of owner default.

Thus, a need exists for systems and methods by which a default by either the owner and/or the contractor can be cured in an efficient and immediate manner, without the delays and/or costs incurred by reason of the surety's investigation and/or denial of a bond claim. In particular, a need exists for systems and methods by which, in the event of a contractor default, the necessary labor, materials, equipment, resources and funds can be immediately supplied so as to permit construction of the project to move forward as designed, on time and on budget and, in the event of an owner default, contractors are assured prompt payment for labor, materials and equipment supplied to the project. These and other needs are addressed by the systems and methods of the present disclosure.

### SUMMARY

In accordance with computer-based embodiments of the present disclosure, exemplary methods for advancing construction project performance and completion are disclosed, wherein a contract exists between a first party and a second party, that generally include determining, using a computer, a need for at least one performance guarantee by accessing at least one database that contains at least one of a plurality of known or reference performance factors and a plurality of known or reference credit factors and analyzing at least one of a plurality of performance factors and a plurality of credit factors based on at least one of the plurality of known or reference performance factors and the plurality of known or reference credit factors. The exemplary method generally further includes determining, using the computer, an amount of at least one letter of credit by accessing the at least one database that contains at least one of the plurality of known or reference performance factors and the plurality of known or reference credit factors and analyzing at least one of the plurality of performance factors and the plurality of credit factors based on at least one of the plurality of known or reference performance factors and the plurality of known or reference credit factors.

The plurality of known or reference performance factors, the plurality of known or reference credit factors, the plurality of performance factors, and/or the plurality of credit factors can be at least one of, e.g., the corporate name; the corporate address; the date of incorporation; the state of incorporation; the website; the tax ID; an indication whether the entity is a union or non-union; the contracting specialty; geographic areas of operation; names of owners, partners, and/or principals; dates of birth of owners, partners, and/or principals; social security numbers of owners, partners, and/or principals; the percent of ownership of owners, partners, and/or principals; the existence of personal indemnity; history of bankruptcy filing by the entity and/or its owners, partners, and/or principals; history of litigation by the entity and/or its owners, partners, and/or principals; the percentage of public and/or private work; the percent of work completed by its own forces; the percent of work subcontracted; the trades subcontracted; the current volume of work; the uncompleted backlog of work; the largest job expected within the next year; the five largest contracts and their price, profit, completion date, and/or contact information for project representative(s); the annual average volume of work; the anticipated nature, cost and/or duration of the current project(s); whether the entity owns and/or leases equipment; terms of leased equipment; corporate assets; accounting records from a CPA; tax information; financial statements; reports from accounting software; the five largest suppliers; the five largest subcontractors; the key personnel to operations and years of experience; life insurance information; business insurance information; existence and information on corporate subsidiaries and/or affiliates; the business plan; a bank line of credit agreement; any corporate buy and/or sell agreements; certificates of insurance; resumes of owners, partners and/or principals; letters of recommendation; history of project defaults; evidence of financial solvency; availability of project funding; and the like.

The at least one letter of credit is generally incorporated into the at least one performance guarantee. The at least one performance guarantee is generally incorporated into at least one of, e.g., the contract, a surety bond, and the like. Upon a default by at least one of the first party and the second party, at least one of the at least one performance guarantee and the at least one letter of credit is implemented to cure the default.

The first party is generally an owner and the second party is generally a contractor. Although the first party and the second party are discussed herein for exemplary purposes as an owner and a contractor, respectively, it should be understood that in alternative exemplary embodiments, the first party can be at least one of, e.g., an owner, a surety, a contractor, a general contractor, a subcontractor, a construction manager, a supplier, an energy exploration or extraction company, and the like, and the second party can be at least one of, e.g., an owner, a surety company, a contractor, a general contractor, a subcontractor, a construction manager, a supplier, an energy exploration or extraction company, and the like. According to the present disclosure, at least one of the first party and the second party apply for the at least one performance guarantee.

The step of the exemplary method of using the computer to determine a need for the at least one performance guarantee generally includes analyzing, using the computer, at least one of the plurality of performance factors and the plurality of credit factors of at least one of the first party and the second party based on at least one of the known or reference performance factors and the known or reference credit factors. The step of the exemplary method of using the computer to determine the amount of the at least one letter of credit generally further includes analyzing, using the computer, at least one of the plurality of performance factors and the plurality of credit factors of at least one of the first party and the second party based on at least one of the known or reference performance factors and the known or reference credit factors.

The at least one performance guarantee generally establishes at least one event of default and at least one time period for curing the at least one event of default. The at least one event of default can be at least one of, e.g., an owner default, a general contractor default, a subcontractor default, a construction manager default, a supplier default, an energy exploration or extraction company default, a surety default, and the like. The owner default can be at least one of, e.g., a failure to make a timely payment, a bankruptcy filing by the owner, a failure to provide required, timely or accurate information, a failure to provide access to the construction site, and the like. The general contractor default, the subcontractor default, the construction manager default, the supplier default, the energy exploration or extraction company default, or the surety default can be at least one of, e.g., a failure to supply labor, a failure to supply materials, a failure to supply equipment, a failure to perform in compliance with a construction schedule, a failure to complete the construction project for an agreed price, a failure to make a payment, a failure to discharge a mechanic's lien filed against the construction project, a failure to secure and maintain a required insurance, a failure to remedy damages to person, property and/or the environment caused by a contractor, a bankruptcy filing by the contractor, and the like.

The at least one letter of credit of the exemplary method can be an irrevocable letter of credit issued by a financial institution, e.g., a bank, and the like. The financial institution is generally a federally insured financial institution rated investment grade or higher. Implementing at least one of the at least one performance guarantee and the at least one letter of credit to cure the default generally further includes granting the at least one time period for curing the at least one event of default to a defaulting party and, upon failure to cure the at least one event of default, drawing upon the at least one letter of credit by a non-defaulting party, i.e., the beneficiary, in accordance with the at least one performance guarantee.

In accordance with embodiments of the present disclosure, exemplary systems for advancing a construction project performance and completion are disclosed, wherein a contract exists between a first party and a second party, that generally include a computer storage device to store known or reference performance factors and known or reference credit factors, and a processing device to determine a need for at least one performance guarantee and to determine an amount of at least one letter of credit. The need for at least one performance guarantee is generally determined by accessing, using a computer, at least one database that contains at least one of the plurality of known or reference performance factors and the plurality of known or reference credit factors and analyzing, using the computer, at least one of a plurality of performance factors and a plurality of credit factors based on at least one of the plurality of known or reference performance factors and the plurality of known or reference credit factors. The amount of at least one letter of credit is generally determined by accessing, using a computer, the at least one database that contains at least one of the plurality of known or reference performance factors and the plurality of known or reference credit factors and analyzing, using the computer, at least one of the plurality of performance factors and the plurality of credit factors based on at least one of the plurality of known or reference performance factors and the plurality of known or reference credit factors. The at least one letter of credit is generally incorporated into the at least one performance guarantee. The at least one performance guarantee is generally incorporated into at least one of, e.g., the contract, a surety bond, and the like. At least one of the at least one performance guarantee and the at least one letter of credit may be implemented upon a default by at least one of the first party and the second party to cure the default.

The at least one performance guarantee generally establishes at least one event of default and at least one time period for curing the at least one event of default. The at least one event of default is at least one of, e.g., an owner default, a general contractor default, a construction manager default, a supplier default, an energy exploration or extraction company default, a surety default, and the like. The at least one letter of credit can be an irrevocable letter of credit. The exemplary systems generally further include a financial institution, e.g., a bank, and the like, issuing the at least one letter of credit. The financial institution is generally a federally insured financial institution rated investment grade or higher. The exemplary systems further include a communications network for communication between, e.g., the first party, the second party, the financial institution, and the like.

Other objects and features will become apparent from the following detailed description considered in conjunction with the accompanying drawings. It is to be understood, however, that the drawings are designed as an illustration only and not as a definition of the limits of the invention.

### BRIEF DESCRIPTION OF THE DRAWINGS

To assist those of skill in the art in making and using the disclosed systems and methods, reference is made to the accompanying figures, wherein:

FIG. 1 is a flow chart of a conventional construction and financing architecture of the prior art;

FIG. 2 is a flow chart of a conventional construction and financing architecture of the prior art;

FIG. 3 is a flow chart of an exemplary embodiment of a system for advancing construction project performance and completion;

FIG. 4 is a flow chart of an exemplary embodiment of a system for advancing construction project performance and completion;

FIG. 5 is a block diagram of an exemplary embodiment of a computing device configured to implement embodiments of a system for advancing construction project performance and completion; and

FIG. 6 is a block diagram of an exemplary computing system configured to implement embodiments of a system for advancing construction project performance and completion.

### DESCRIPTION OF EXEMPLARY EMBODIMENTS

In accordance with embodiments of the present disclosure, exemplary methods and systems for advancing construction project performance and completion are disclosed that generally include creating a contract between a first party and a second party, determining, using a computer, a need for at least one performance guarantee, and determining, using a computer, an amount of at least one letter of credit. The at least one letter of credit is incorporated into the at least one performance guarantee. The at least one performance guarantee is incorporated into at least one of, e.g., the contract, a surety bond, and the like. Upon a default by at least one of the first party and the second party, at least one of the at least one performance guarantee and the at least one letter of credit is implemented by the non-defaulting party, i.e., the beneficiary, to cure the default.

In accordance with at least one embodiment of the present disclosure, the exemplary methods and systems, i.e., a construction and financing process and architecture, may be implemented to better advance construction projects such that they are completed as designed, on time and on budget, with owners assured the benefit of their bargain, and the contractors performing the work assured prompt payment for work properly performed. These methods, systems and architecture may be used for the construction and/or renovation of public and/or private projects in a manner which can eliminate or reduce, e.g., project delays, cost overruns, damages caused by construction and development activities, and the like, thereby benefiting all interested parties, including, for public projects, the taxpayers funding the projects and the municipalities that serve them.

The exemplary embodiments that are disclosed herein provide an alternative, novel approach, to the currently existing methods by which owners, both public and private, and other interested parties, seek to advance their construction and development improvement projects, which for the purposes hereof include, but are not limited to, e.g., energy exploration and extraction activities, and the like, such that they are constructed as designed, on time and on budget, with a minimization of damages to person, property and/or the environment resulting from those activities. The exemplary embodiments disclosed herein further better advance construction and development improvement projects such that they are performed and completed in accordance with the contract documents and that contractors are generally ensured payment for work properly performed. It should be understood that the exemplary systems and methods can be implemented in a wide range of business scenarios wherein or whereby one or more parties are obligated to, e.g., supply labor, supply materials, supply equipment, supply funds, provide other resources related to construction and development activities, provide resources to remedy the loss and/or damages caused by an entities' construction and development activities, and the like.

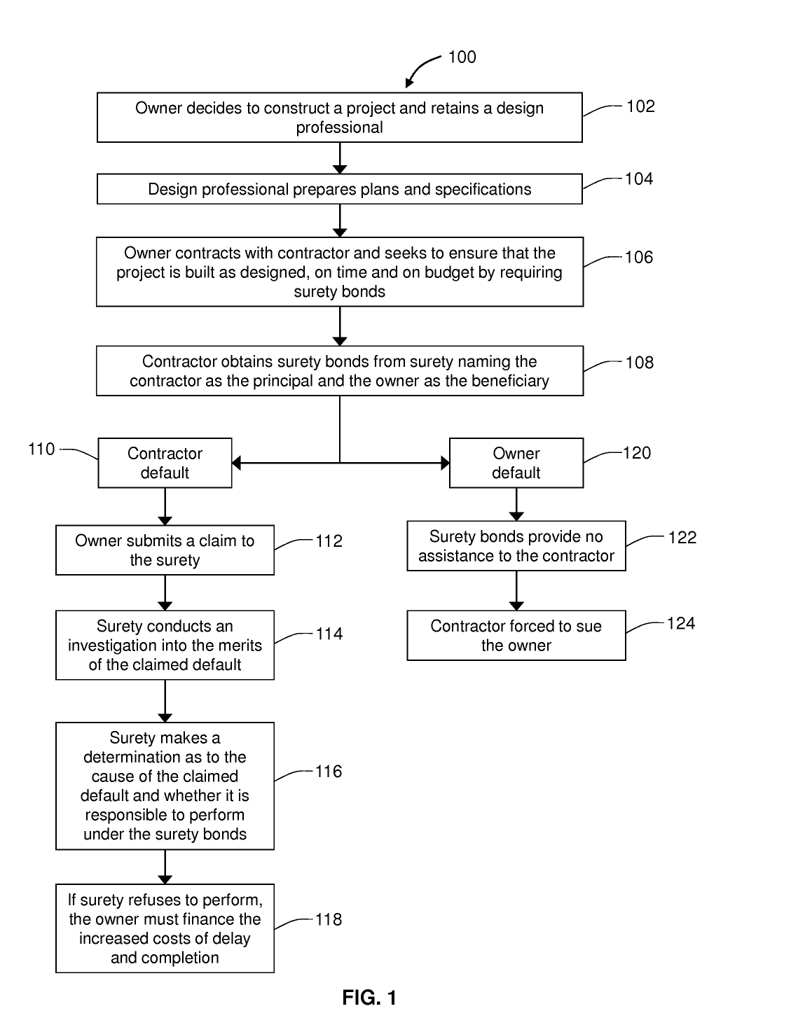

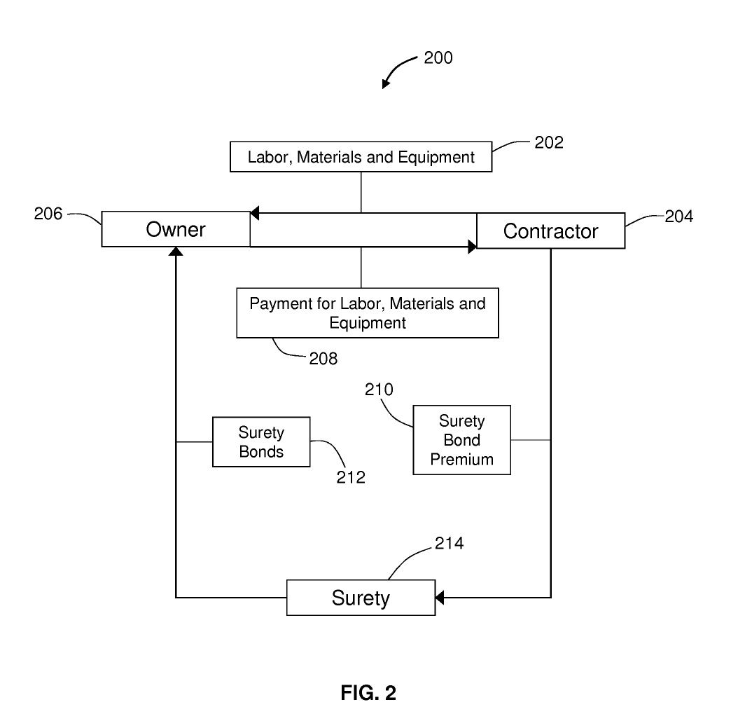

Turning now to FIGS. 1 and 2, flow charts of a conventional construction and financing architecture, i.e., systems and methods 100 and 200, of the prior art are illustrated. It should be understood that the actions performed and/or represented in FIGS. 1 and 2 are merely illustrative of the construction and financing architecture that is conventionally utilized and the steps taken in the event of contractor 204 or owner 206 default. Further, alternative construction and financing architectures may omit, in whole or in part, one or more steps illustrated in FIGS. 1 and 2. While steps may be omitted in whole or in part, such omissions do not reduce the utility, value or applicability of the exemplary systems and methods of the present disclosure which are discussed in detail below.

With specific reference to FIG. 1, the owner 206 initially decides to construct a project, e.g., a construction project, an improvement project, and the like, and retains a design professional (102). The design professional prepares the plans and specifications for completing the project (104). Once an owner 206 contracts with a contractor 204, under the conventional system, owners 206 and interested parties, both public and private, generally attempt to advance their projects such that they are completed as designed, on time and on budget, by requiring the project's contractor 204 to supply, e.g., bid, performance, payment, surety bonds 212, and the like, issued by a construction surety 214 (106). The surety bonds 212 are issued by a surety 214, naming the contractor 204 as the principal and the owner 206 as the beneficiary (108).

With specific reference to FIG. 2, a flow chart illustrates the relationship between the parties involved in a conventional construction and financing architecture, i.e., systems and methods 100 and 200, such as, e.g., the owner 206, the contractor 204, the surety 214, and the like. In general, the contractor 204 supplies the labor, materials and/or equipment 202 in exchange for a payment for the labor, materials and/or equipment 208 from the owner 206. In exchange for a surety bond premium 210, the surety 214 issues at least one surety bond 212 to the owner 206.

Still with reference to FIG. 1, in the event of a contractor 204 default (110), the owner 206 is required to submit a claim to the surety 214 to initiate an investigation by the surety 214 (112). The surety 214 generally conducts an investigation into the merits of the claimed default, including requesting information and/or documentation from the parties involved with the claimed default and/or any other interested or retained party, e.g., the owner 206, contractor 204, subcontractor, and the like (114). After completing the investigation, the surety 214 makes a determination as to the cause of the claimed default and whether it is responsible to perform under the surety bonds 212 (116). If, after the investigation, the surety 214 refuses to perform, the owner 206 must finance the increased costs of delay and completion of the project (118).

As discussed herein, a contractor 204 default includes, e.g., instances where the contractor 204 refuses, neglects or fails to supply the labor, materials or equipment required; the contractor 204 refuses, neglects or fails to perform the work in full compliance with the project's construction schedule; the contractor 204 refuses, neglects or fails to complete the project for the agreed price; the contractor 204 refuses, neglects or fails to timely make payments due to any of its subcontractors or suppliers; the contractor 204 refuses, neglects or fails to discharge any mechanic's lien filed against the project; the contractor 204 refuses, neglects or fails to secure and maintain all required insurance; the contractor 204 refuses, neglects or fails to remedy damages caused by the contractor 204 to person, property or the environment; the contractor 204 or any of its parent companies, affiliates or subsidiaries files for bankruptcy; and the like. Under the conventional construction and financing architecture, a contractor 204 default generally delays the project and causes the project owner 206 to incur additional costs related to the delay, completion, and/or correction of the contractor's 204 work.

Still with reference to FIG. 1, in the event of an owner 206 default (120), under the conventional construction and financing architecture, surety bonds 212 generally provide no assistance to the contractor 204 (122). Owner 206 default generally results in those who supplied labor, materials or equipment to the project receiving no payment, a late payment and/or a reduced payment. In general, as the only remaining remedy, the contractor 204 may be forced to sue the owner 206 to receive the full payment deserved (124). Thus, in the event of owner 206 default, the conventional construction and financing architecture may result in, e.g., layoffs, drive companies out of business, force bankruptcy filings, leads contractors 204 to increase their prices on both private and taxpayer funded projects so as to guard against the risk of non-payment and/or delayed payment, and the like. As discussed herein, owner 206 default includes, e.g., instances where the owner 206 refuses, neglects or fails to make timely payment to the contractor 204 for work approved; the owner 206 and/or any of its parent companies, affiliates or subsidiaries files for bankruptcy, the owner 206 fails to provide required, timely and/or accurate information, the owner 206 fails to provide access to the construction site, and the like.

The deficiencies discussed above with respect to the methods and systems 100 and 200 of the prior art affect the attractiveness, efficiency and/or safety of construction and development projects across the country. In particular, these deficiencies generally result in, e.g., an unnecessary overabundance of delayed and stalled projects, cost overruns, wasted taxpayer dollars, unpaid contractors, layoffs, damages to person, property and the environment, litigation among project participants, and the like. The exemplary systems and methods for advancing construction project performance and completion disclosed herein generally eliminate and/or reduce the deficiencies of the prior art.

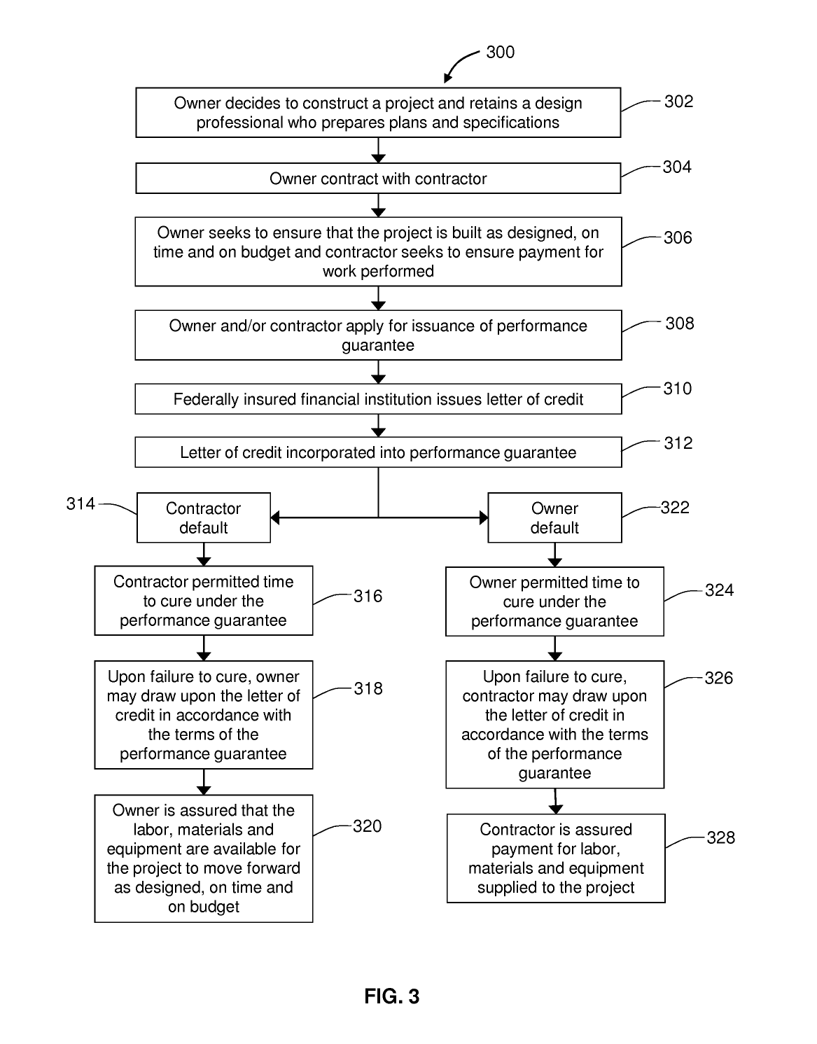

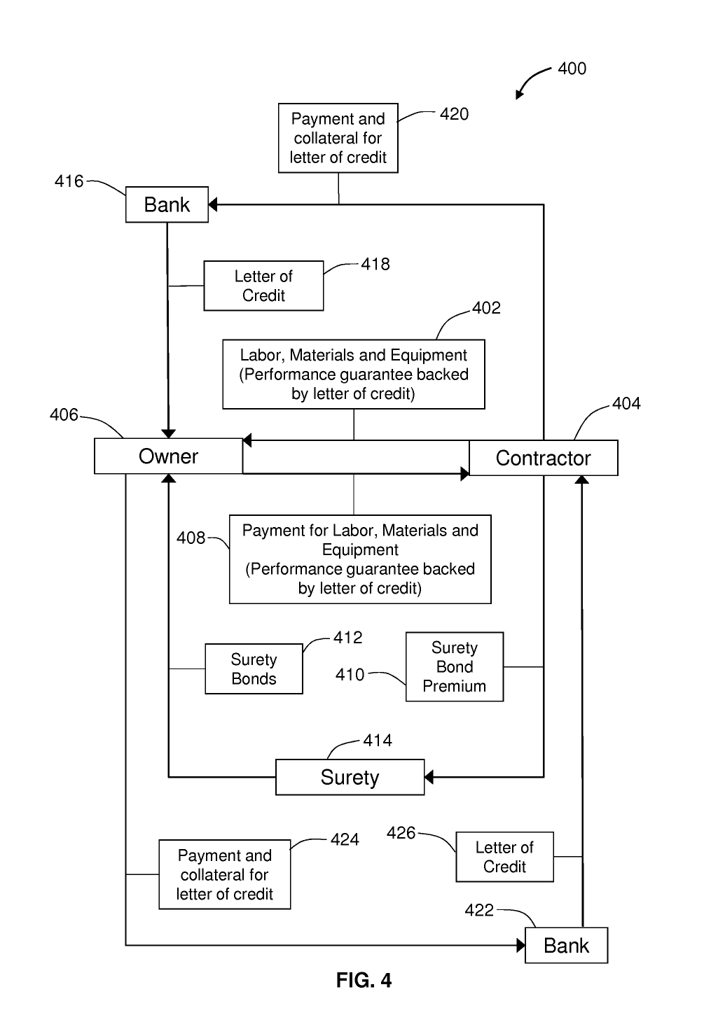

Turning now to FIGS. 3 and 4, flow charts of exemplary systems and methods 300 and 400 directed to advancing construction project performance and completion are provided. Although illustrated as including two financial institutions 416, 422, two letters of credit 418, 426, an owner 406, a contractor 404 and a surety 414, it should be understood that in other exemplary embodiments, more and/or less of the parties or components involved may be implemented. For example, the exemplary systems and methods 300 and 400 can include, e.g., one, two, three, four, five, six, and the like, letters of credit 418, 426, and, e.g., one, two, three, four, five, six, and the like, financial institutions 416, 422. Similarly, alternative exemplary embodiments can include, e.g., owners 406, contractors, 404, sureties 414, subcontractors, suppliers, energy exploration and extraction companies, and the like.

Still with reference to FIGS. 3 and 4, the exemplary systems and methods 300 and 400 apply proprietary performance guarantees to the parties' construction and development obligations as they relate to the specified and agreed supply of labor, materials, equipment, funds, and other resources to the parties' construction and development activities. The performance guarantees incorporate irrevocable letters of credit 418, 426 issued by federally insured financial institutions 416, 422, e.g., banks, and the like, rated investment grade or higher. These proprietary guarantees are incorporated into, e.g., the parties' agreement and/or contract, the project's surety bonds 412, and the like, and set forth events of default and time periods for cure. Upon an event of default and/or failure to cure, the owner 406 and/or the contractor 404 may immediately draw against the applicable letter of credit 418, 426, which provides the resources necessary to immediately remedy the contractor 404 and/or the owner 406 default. For owners 406, the exemplary architecture permits projects to move forward on time and on budget, and/or cure or reduce damages sustained, notwithstanding contractor 404 default. For contractors 404, the exemplary architecture provides timely payment for work performed, notwithstanding owner 406 default. For both owners 406 and contractors 404, the exemplary systems and methods 300 and 400, e.g., eliminate and/or reduce the costs and delays caused by the other parties' default, provide immediate funds to remedy and/or reduce any damages to person, property or the environment caused by the construction or development activities, eliminate and/or substantially reduce risks associated with bankruptcy filings and the “automatic stay” requirements thereof, and the like.

With specific reference to FIG. 3, the owner 406 initially decides to construct a project, e.g., a construction project, an improvement project, and the like, and retains a design professional who prepares plans and specifications (302). Based on the preparation of the plans and specifications by the design professional and/or on bids provided by contractors 404, the owner 406 contracts with a contractor 404 (304). The owner can be considered as the first party and the contractor can be considered as the second party to the contract. Although the first party and the second party are discussed herein as an owner and a contractor, respectively, it should be understood that in alternative exemplary embodiments, the first party can be, e.g., an owner, a contractor, a surety, and the like, and the second party can be, e.g., an owner, a contractor, a surety, and the like. In further exemplary embodiments, the first party can be, e.g., an owner, a surety, a contractor, a general contractor, a subcontractor, a construction manager, a supplier, an energy exploration or extraction company, and the like, and the second party can be, e.g., an owner, a surety, a contractor, a general contractor, a subcontractor, a construction manager, a supplier, an energy exploration or extraction company, and the like.

The owner 406 generally seeks to ensure that the project is built as designed, on time and/or on budget and the contractor 404 generally seeks to ensure payment for the work performed (306). Thus, the owner 406 and/or the contractor 404 apply for issuance of a performance guarantee, which generally sets forth the events of default and time periods for curing the default (308). A federally insured financial institution 416, 422, e.g., a bank, and the like, generally rated investment grade or higher issues a letter of credit 418, 426 (310). Although discussed herein as one performance guarantee and one letter of credit 418, 426, it should be understood that in other exemplary embodiments, one, two, three, four, five, and the like, performance guarantees and/or letters of credit 418, 426 can be implemented. Once a letter of credit 418, 426 is issued by the financial institution 416, 422, the letter of credit 418, 426 is incorporated into the performance guarantee (312). Further, the performance guarantee can be incorporated into the contract between the parties and/or the project surety bond 412 issued by the surety 414 in exchange for a surety bond premium 410.

Thus, a letter of credit 418 can be obtained by the contractor 404 to guarantee that, e.g., labor, materials and/or equipment 402 will be provided to the owner 406 as agreed upon in the contract. Since the performance guarantee runs in favor of the owner 406 (to assure that the project is completed as designed on time and on budget), the owner 406 is the beneficiary and the contractor 404 is the applicant. Similarly, a letter of credit 426 can be obtained by the owner 406 to guarantee that, e.g., payment for labor, materials and/or equipment 408 will be provided to the contractor 404 as agreed upon in the contract. Since the performance guarantee runs in favor of the contractor 404 (to assure payment for work performed), the contractor 404 is the beneficiary and the owner 406 is the applicant. In the event of a default by a contractor 404, the owner 406 can rely on the performance guarantee and/or the letter of credit 418 and, in the event of an owner 406 default, the contractor 404 can rely on the performance guarantee and/or the letter of credit 426. In particular, in the event of a default, the defaulting party is permitted time to cure the default under the performance guarantee. If the defaulting party fails to cure the default under the performance guarantee, the beneficiary, i.e., the non-defaulting party, may draw upon the appropriate letter of credit 418, 426 in accordance with the terms of the performance guarantee to prevent a delay in the construction project, prevent delayed payment, remedy and/or minimize damages to person, property and/or environment, and the like.

In the event of a contractor 404 default (314), under the performance guarantee, the contractor 404 is permitted a specified time period to cure the default (316). If the default is cured during the time period specified in the performance guarantee, the contract and/or construction project can proceed accordingly. However, upon a failure by the contractor 404 to cure the default, the owner 406 may draw upon the letter of credit 418 in accordance with the terms of the performance guarantee (318). Thus, the letter of credit 418 assures the owner 406 that the labor, materials and/or equipment 402 are available for the project to move forward as designed, on time and/or on budget (320).

In the event of an owner 406 default (322), under the performance guarantee, the owner 406 is permitted a specified time period to cure the default (324). If the default is cured during the time period specified in the performance guarantee, the contract and/or construction project can proceed accordingly. However, upon a failure by the owner 406 to cure the default, the contractor 404 may draw upon the letter of credit 426 in accordance with the terms of the performance agreement (326). Thus, the letter of credit 426 assures the contractor 404 that payment for labor, materials and/or equipment 408 is supplied for the project and/or to the contractor 404 (328). In particular, the exemplary systems and methods 300 and 400 advance construction project performance and completion such that upon an event of default and failure to cure, owners 406 and/or contractors 404 can immediately call upon funds to remedy the contractor 404 and/or owner 406 default. Therefore, the exemplary systems and methods 300 and 400 can save and/or avoid months of project delays and/or cost overruns that are inherent to alternative solutions currently existing in the construction industry.

With reference to FIG. 4, a flow chart illustrates the relationship between the parties involved in the exemplary systems and methods 300 and 400, such as, e.g., the owner 406, the contractor 404, the surety 414, the financial institutions 416, 422, and the like. In general, the contractor 404 supplies the labor, materials and/or equipment 402 in exchange for a payment for the labor, materials and/or equipment 408 from the owner 406. The contract between the parties directed to supplying labor, materials and/or equipment 402 incorporates a performance guarantee backed by a letter of credit 418. Similarly, the contract between the parties directed to making payments for the labor, materials and/or equipment 408 incorporates a performance guarantee backed by a letter of credit 426. In exchange for a surety bond premium 410, the surety 414 may issue at least one surety bond 412 to the owner 406. Financial institutions 416, 422, e.g., banks, and the like, can issue letters of credit 418, 426 to the owner 406 and/or the contractor 404. In particular, in exchange for a payment and/or collateral 420 by the contractor 404 for the letter of credit 418, the financial institution 416 issues a letter of credit 418 to the owner 406. The letter of credit 418 can be sufficient to include the funds for the labor, materials and/or equipment 402 and/or to remedy damages in the event of a default by the contractor 404. In exchange for a payment and/or collateral 424 by the owner 406 for the letter of credit 426, the financial institution 422 issues a letter of credit 426 to the contractor 404. The letter of credit 426 can be sufficient to include the funds for payment for the labor, materials and/or equipment 408 and/or to remedy damages in the event of a default by the owner 406.

As discussed above, FIGS. 3 and 4 illustrate exemplary systems and methods 300 and 400, i.e., a construction and financing architecture, which may be implemented to, e.g., avoid and/or to fully or partially remedy the delays caused and resulting costs incurred by reason of a surety's 414 investigation into whether the contractor 404 is or is not in default, the delays and costs caused by a contractor's 404 supply of inaccurate information, the delays and costs caused by a rejection of the owner's 406 claim of default, the resulting costs incurred by the owner 406 to complete the project on time and/or to remedy or reduce the damages to person, property or the environment caused by the contractor 404, and the like. It should be understood that the actions performed in FIGS. 3 and 4 are merely illustrative of particular implementation options in accordance with at least one embodiment of the present disclosure. Therefore, it is not necessary that the actions be performed in the order illustrated in FIGS. 3 and 4. Rather, each of those actions may be performed in various orders, including simultaneously. Moreover, it should be understood that practice of the exemplary systems and methods 300 and 400 may not require performing all of the operations set forth in FIGS. 3 and 4 and/or that those operations be performed specifically by the owner 406 or contractor 404. Instead, some exemplary operations may readily be performed by other private and/or public third party entities.

The exemplary embodiments illustrated in FIGS. 3 and 4 further provide a potential implementation of the above described systems and methods 300 and 400 to, e.g., avoid and/or to fully or partially remedy the damages caused by an owner's 406 default, or non-payment for labor, materials or equipment supplied to the project, the resulting layoffs, business closures, and increased contractor pricing, on both private and taxpayer funded projects, resulting from such default, failure to pay, delayed payment, or uncertainty of payment for work performed, and the like.

As discussed above, the irrevocable letters of credit 418, 426 issued by the federally insured financial institutions 416, 422 generally rated investment grade or higher are incorporated into the parties' performance guarantees and/or surety bonds and may be called upon in the event of a contractor 404 and/or owner 406 default. The essentiality and amount of the performance guarantees and letters of credit 418, 426, respectively, for any given project may be determined using computational means, thereby allowing the parties to maximize efficiency and/or minimize costs. The computational means include, e.g., a computer program, computer processing device electronically performing processing operations, and the like. One exemplary embodiment includes determining computer-generated credit factors associated with the construction financing and/or past performance of the party supplying the performance guarantee and/or requesting the letter of credit 418, 426 on previous construction and development projects. This determination may include, e.g., the accessing, assembling, processing, collating, or any other suitable data processing or manipulation of available electronic data, such as, for example, demand, credit and/or performance data available from one or more electronic data repositories, as recognized by one skilled in the art. The computational means may also include electronic delivery of the demand, credit and/or performance factors determined using the processing and/or computational machine or device. The electronic delivery can be via any suitable means, including data transmission using known or any suitable data transmission techniques, but may also include physical delivery, such as data storage on a physical readable medium and the delivery consummated when the data is read from the storage medium.

It should be understood that various aspects of the embodiments of the present disclosure may be implemented in, e.g., hardware, firmware, software, combinations thereof, and the like. In such embodiments, the various components and/or steps would be implemented in hardware, firmware and/or software to perform the functions of the present disclosure. That is, the same piece of hardware, firmware and/or module of software could perform one or more of the illustrated components and/or steps.

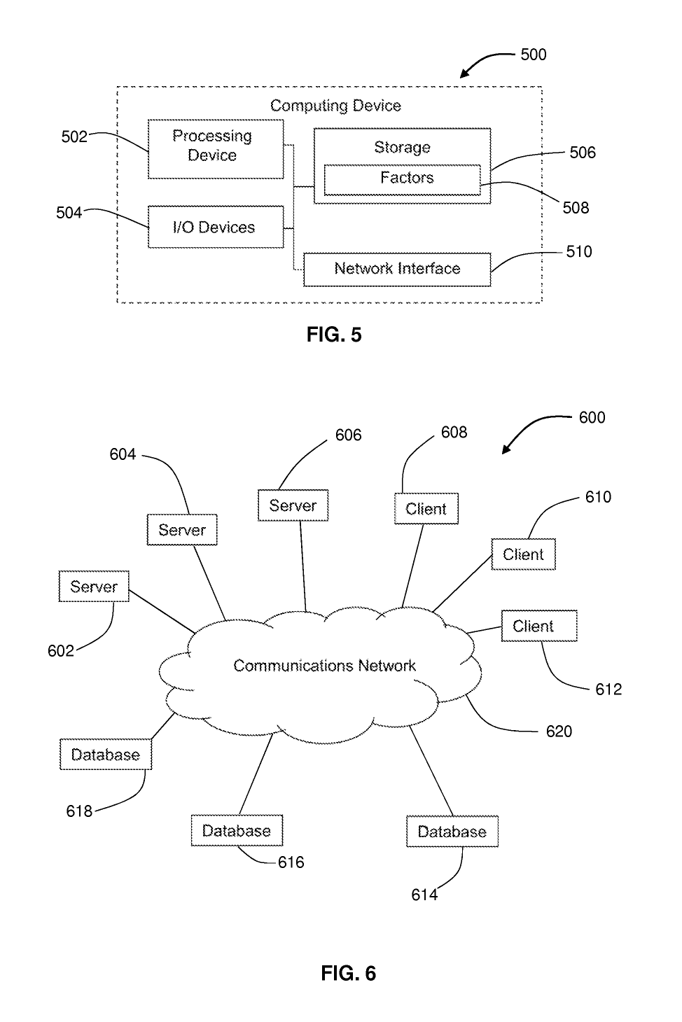

FIG. 5 is a block diagram of an exemplary computing device 500 which is configured to implement some embodiments of the systems 300 and 400. The computing device 500 can be, e.g., a mainframe, personal computer (PC), laptop computer, workstation, server, handheld device, such as a portable digital assistant (PDA), and the like. In the illustrated embodiment, the computing device 500 includes a processing device 502, such as a central processing unit, and can include storage 506. The computing device 500 can further include input/output devices 504, such as a display device, keyboard, touch screen, mouse, printer, and the like, and can include a network interface 510 to facilitate communication between the computing device 500 and other devices communicative coupled to a network.

The storage 506 stores data and instructions and can be implemented using non-transitory computer readable medium technologies, such as a floppy drive, hard drive, tape drive, solid state storage devices, Flash drive, optical drive, read only memory (ROM), random access memory (RAM), and the like. For example, the storage 506 can store factors 508 considered by the computing device 500 in determining the necessity for a performance guarantee and/or the amount of the letter of credit 418, 426. The factors 508 can be, e.g., known and/or reference performance factors, known and/or reference credit factors, and the like. The factors 508 can further be, e.g., performance and/or credit factors related to the owner 406 and/or the contractor 404 involved in the current construction contract during previous construction projects, performance and/or credit factors known in the industry and/or collected from the industry, including owners 406, contractors 404, and subcontractors not involved in the current construction contract, and the like.

The factors 508 can be at least one of, e.g., the corporate name; the corporate address; the date of incorporation; the state of incorporation; the website; the tax ID; an indication whether the entity is a union or non-union; the contracting specialty; geographic areas of operation; names of owners, partners, and/or principals; dates of birth of owners, partners, and/or principals; social security numbers of owners, partners, and/or principals; the percent of ownership of owners, partners, and/or principals; the existence of personal indemnity; history of bankruptcy filing by the entity and/or its owners, partners, and/or principals; history of litigation by the entity and/or its owners, partners, and/or principals; the percentage of public and/or private work; the percent of work completed by its own forces; the percent of work subcontracted; the trades subcontracted; the current volume of work; the uncompleted backlog of work; the largest job expected within the next year; the five largest contracts and their price, profit, completion date, and/or contact information for project representative(s); the annual average volume of work; the anticipated nature, costs and/or duration of the current project(s); whether the entity owns and/or leases equipment; terms of leased equipment; corporate assets; accounting records from a CPA; tax information; financial statements; reports from accounting software; the five largest suppliers; the five largest subcontractors; the key personnel to operations and years of experience; life insurance information; business insurance information; existence and information on corporate subsidiaries and/or affiliates; the business plan; a bank line of credit agreement; any corporate buy and/or sell agreements; certificates of insurance; resumes of owners, partners and/or principals; letters of recommendation; history of project defaults; evidence of financial solvency; availability of project funding; and the like.

The factors 508 can be populated into storage 506 by, e.g., collecting the factors 508 from an application completed by a party prior to issuance of the letter of credit 418, 426 and/or the performance guarantee, independent research and/or investigation on the party applying for the letter of credit 418, 426 and/or the performance guarantee, such research and/or investigation being authorized as part of the application process, and the like. The application may be completed, e.g., in person, over a network, online, and the like. The factors 508 collected may be maintained in a storage 506 for future comparison and/or analyzing based on an applicant's factors 508.

The storage 506 can further store, e.g., a library of proprietary performance guarantees which incorporate irrevocable letters of credit 418, 426. The factors 508 and information stored in the storage 506 can be processed and/or analyzed by the processing device 502 in response to input by a client, e.g., a contractor 404, an owner 406, a financial institution 416, 422, a surety 414, and the like, and return desired information, e.g., the necessity of a performance guarantee, the amount of a letter of credit 418, 426, and the like. Applications, such as an embodiment of the systems 300 and 400, or portions thereof, can be resident in the storage 506 and can include instructions for implementing the applications. The storage 506 can be local or remote to the computing device 500. The processing device 502 operates to execute the applications in storage 506, such as the systems 300 and 400, by executing instructions therein and storing data resulting from the executed instructions, which can be presented via, for example, a graphical user interface (GUI).

FIG. 6 is a block diagram of an exemplary computing system 600 configured to implement one or more embodiments of the systems 300 and 400. The computing system 600 includes servers 602-606 operatively coupled to clients 608-612, e.g., contractors 404, owners 406, financial institutions 416, 422, sureties 414, and the like, via a communication network 620, which can be any network over which information can be transmitted between devices communicatively coupled to the network. For example, the communication network 620 can be the Internet, Intranet, virtual private network (VPN), wide area network (WAN), local area network (LAN), and the like. The computing system 600 can include repositories or database devices 614-618, which can be operatively coupled to the servers 602-606, as well as to clients 608-612, via the communications network 620. The servers 602-606, clients 608-612, and database devices 614-618 can be implemented as computing devices 500. Those skilled in the art will recognize that the database devices 614-618 can be incorporated into one or more of the servers 602-606 such that one or more of the servers 602-606 can include databases 614-618.

In exemplary embodiments, portions of the systems 300 and 400 can be distributed among different devices, e.g., servers, clients, databases, in the communication network 620 such that one or more components of the systems 300 and 400, or portions thereof, can be implemented by different devices in the communication network 620. For example, clients 608-612 can represent the contractors 404, owners 406, financial institutions 416, 422, sureties 414, and the like, implementing a computing device 500 having a web browser and/or a graphical user interface, where the clients 608-612 can use the computing devices 500 to input, e.g., construction project information, contractor 404 information, owner 406 information, and the like, into a GUI over the network 620 and further receive, e.g., the necessity of a performance guarantee, the amount of a letter of credit 418, 426 over the network 620 in a format understandable to the clients 608-612. The database devices 614-618 can be configured to store a variety of information relevant and/or applicable to the construction, development and/or energy industry and/or the determination of the necessity of a performance guarantee and the amount of a letter of credit 418, 426, e.g., performance and/or credit factors related to the owner 406 and/or the contractor 404 involved in the current construction contract during previous construction projects, performance and/or credit factors known in the industry and/or collected from the industry, including owners 406, contractors 404, and subcontractors not involved in the current construction contract, a library of proprietary performance guarantees which incorporate irrevocable letters of credit 418, 426, and the like.

It should be noted that the exemplary embodiments of systems 300 and 400 can include a variety of database devices 614-618 having various database file configurations and data file formats. The database devices 614-618 can also include, e.g., software programs, programming code and program modules. Database file configurations can be, e.g., Microsoft Office Excel Comma Separated Values File format, Microsoft Access Database File format, or the like. Data files can contain, e.g., text, graphic, media or other data formats pertinent to the construction industry. The software programs, code or modules can be in a programming language, machine code or other format usable by a microprocessor, computer and/or computing system. Some of the database files, data files or programs can be stored on, e.g., non-volatile hard drives, or within, e.g., solid-state memory device, or the like.

As discussed herein, the database, database file, data file, program, code, program module, and the like, can be stored in a data store. A data store generally includes, e.g., single and/or multiple non-volatile memory device(s), other types of non-volatile computer readable mediums adapted to store databases, database files, data files, programs, codes or program modules, and the like. The non-volatile memory device(s) can include one or more types of nonvolatile memory, including, e.g., electro-mechanical, magnetic, optical, flash, other solid state or non-solid state types of non-volatile memory, and the like. As would be understood by one of ordinary skill in the art, database file information, data file information and software do not always reside in non-volatile memory. Instead, database file information, data file information and software can also be stored temporarily during operation of the exemplary systems in various types of volatile memory. Furthermore, other types of computer readable mediums can include, without limitation, e.g., magnetic and optical computer readable mediums, flash memory, battery backed volatile memory, reasonable facsimiles or derivations thereof, and the like.

It should be understood that the exemplary embodiments disclosed herein are applicable to, e.g., public, private, commercial and/or residential projects and infrastructure improvements, energy projects such as oil and natural gas exploration and extraction (e.g., “fracking”) to guard against and/or immediately remedy injury caused to person or property by the construction, extraction, and/or exploration activities, windfarm facilities, including use of the exemplary embodiments by surety companies as a means of advancing prompt performance, obtaining security against a default by their principal, reducing their risk of loss, and the like. Thus, the exemplary systems and methods 300 and 400 permit construction and development projects of various natures and types, including tax-payer financed improvements, to move forward as designed, on time and/or on budget in the event of a default. Further, the exemplary systems and methods 300 and 400 provide immediately available funds to cure and/or reduce damages to person and/or property as a result of those operations, or other construction and development activities.

Where certain elements of the exemplary systems and methods 300 and 400 can be partially or fully implemented using components known in the art, only those portions of such known components that are necessary for an understanding of the present systems and methods 300 and 400 are described, and detailed descriptions of other portions of such known components are omitted so as not to obscure the disclosure. In the present disclosure, an exemplary embodiment showing a singular component should not necessarily be limited to other exemplary embodiments including a plurality of the same component, and vice-versa, unless explicitly stated otherwise herein. Further, the present disclosure encompasses present and future known equivalents to the known components referred to herein by way of illustration.

The foregoing description of the specific embodiments will so fully reveal the general nature of the exemplary systems and methods 300 and 400 that others can, by applying knowledge within the skill of the relevant art(s), readily modify and/or adapt for various applications such specific embodiments, without undue experimentations, and without departing from the general concept of the present disclosure. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specifications is to be interpreted by the skilled artisan in light of the teachings and guidance presented herein, in combination with the knowledge of one skilled in the relevant art(s).

While exemplary embodiments have been described herein, it is expressly noted that these embodiments should not be construed as limiting, but rather that additions and modifications to what is expressly described herein also are included within the scope of the invention. Moreover, it is to be understood that the features of the various embodiments described herein are not mutually exclusive and can exist in various combinations and permutations, even if such combinations or permutations are not made express herein, without departing from the spirit and scope of the invention.

1. A method for advancing construction project performance and completion, wherein a contract exists between a first party and a second party, the method comprising:
determining, via a processing device, a need for at least one performance guarantee by accessing at least one of a plurality of known or reference performance factors and a plurality of known or reference credit factors based on one or more parties not involved in the contract and analyzing at least one of a plurality of performance factors and a plurality of credit factors based on at least one of the plurality of known or reference performance factors and the plurality of known or reference credit factors;
determining, via the processing device, an amount of at least one letter of credit by accessing at least one of the plurality of known or reference performance factors and the plurality of known or reference credit factors based on one or more parties not involved in the contract and analyzing at least one of the plurality of performance factors and the plurality of credit factors based on at least one of the plurality of known or reference performance factors and the plurality of known or reference credit factors;
incorporating the at least one letter of credit into the at least one performance guarantee;
incorporating the at least one performance guarantee into at least one of the contract and a surety bond; and
upon a default by at least one of the first party and the second party, implementing at least one of the at least one performance guarantee and the at least one letter of credit to cure the default.

2. The method of claim 1, wherein the first party and the second party are at least one of an owner, a general contractor, a subcontractor, a construction manager, a supplier, an energy exploration or extraction company, and a surety.

3. The method of claim 1, further comprising at least one of the first party and the second party applying for the at least one performance guarantee.

4. The method of claim 1, wherein determining, via the processing device, the need for the at least one performance guarantee further comprises:
analyzing at least one of the plurality of performance factors and the plurality of credit factors of at least one of the first party and the second party based on at least one of the plurality of known or reference performance factors and the plurality of known or reference credit factors.

5. The method of claim 1, wherein determining, via the processing device, the amount of the at least one letter of credit further comprises:
analyzing at least one of the plurality of performance factors and the plurality of credit factors of at least one of the first party and the second party based on at least one of the plurality of known or reference performance factors and the plurality of known or reference credit factors.

6. The method of claim 1, wherein the at least one performance guarantee establishes at least one event of default and at least one time period for curing the at least one event of default.

7. The method of claim 6, wherein the at least one event of default is at least one of an owner default, a general contractor default, a subcontractor default, a construction manager default, a supplier default, an energy exploration or extraction company default, and a surety default.

8. The method of claim 7, wherein the owner default is at least one of (i) a failure to make a timely payment, (ii) a bankruptcy filing by the owner, (iii) a failure to provide required, timely or accurate information by the owner, and (iv) a failure to provide access to a construction site by the owner.

9. The method of claim 7, wherein the general contractor default, the subcontractor default, the construction manager default, the supplier default, the energy exploration or extraction company default, or the surety default is at least one of (i) a failure to supply labor, (ii) a failure to supply materials, (iii) a failure to supply equipment, (iv) a failure to perform in compliance with a construction schedule, (v) a failure to complete the construction project for an agreed price, (vi) a failure to make a payment, (vii) a failure to discharge a mechanic's lien filed against the construction project, (viii) a failure to secure and maintain a required insurance, (ix) a failure to remedy damages to a person, a property or an environment, and (x) a bankruptcy filing.

10. The method of claim 1, wherein the at least one letter of credit is an irrevocable letter of credit.

11. The method of claim 5, further comprising issuing the at least one letter of credit by a financial institution.

12. The method of claim 11, wherein the financial institution is a federally insured financial institution rated investment grade or higher.

13. The method of claim 6, wherein implementing at least one of the at least one performance guarantee and the at least one letter of credit to cure the default further comprises:
granting the at least one time period for curing the at least one event of default to a defaulting party; and
upon failure to cure the at least one event of default, drawing upon the at least one letter of credit by a non-defaulting party in accordance with the at least one performance guarantee.

14. A system for advancing construction project performance and completion, wherein a contract exists between a first party and a second party, the system comprising:
a computer storage device to store a plurality of known or reference performance factors and a plurality of known or reference credit factors; and
a processing device to determine a need for at least one performance guarantee and to determine an amount of at least one letter of credit,
wherein the need for at least one performance guarantee is determined by accessing at least one of the plurality of known or reference performance factors and the plurality of known or reference credit factors based on one or more parties not involved in the contract and analyzing at least one of a plurality of performance factors and a plurality of credit factors based on at least one of the plurality of known or reference performance factors and the plurality of known or reference credit factors;
wherein the amount of at least one letter of credit is determined by accessing at least one of the plurality of known or reference performance factors and the plurality of known or reference credit factors based on one or more parties not involved in the contract and analyzing at least one of the plurality of performance factors and the plurality of credit factors based on the plurality of known or reference performance factors and the plurality of known or reference credit factors;
wherein the at least one letter of credit is incorporated into the at least one performance guarantee and the at least one performance guarantee is incorporated into at least one of the contract and a surety bond; and
wherein at least one of the at least one performance guarantee and the at least one letter of credit is implemented upon a default by at least one of the first party and the second party.

15. The system of claim 14, wherein the at least one performance guarantee establishes at least one event of default and at least one time period for curing the at least one event of default.

16. The system of claim 15, wherein the at least one event of default is at least one of an owner default, a general contractor default, a subcontractor default, a construction manager default, a supplier default, an energy exploration or extraction company default, and a surety default.

17. The system of claim 14, wherein the at least one letter of credit is an irrevocable letter of credit.

18. The system of claim 14, further comprising a financial institution issuing the at least one letter of credit.

19. The system of claim 18, wherein the financial institution is a federally insured financial institution rated investment grade or higher.

20. The system of claim 19, further comprising a communications network for communication between the first party, the second party, and the financial institution.
